(19) United States
(12) Patent Application Publication
(10) Pub. No.: US 2017/0351419 A1
(43) Pub. Date: Dec. 7, 2017

(54) SYSTEMS AND METHODS OF DYNAMICALLY PROVIDING INFORMATION AT DETECTION OF SCROLLING OPERATIONS

(71) Applicant: Bounce Exchange, Inc., New York, NY (US)

(72) Inventors: Ryan Joshua Urban, New York, NY (US); Bing Wu, Flushing, NY (US); Benzion Gribetz Rubin, New York, NY (US); Joseph West, Brooklyn, NY (US); Namik Abdulzade, Middle Village, NY (US)

(21) Appl. No.: 15/615,006

(22) Filed: Jun. 6, 2017

Related U.S. Application Data
(60) Provisional application No. 62/346,814, filed on Jun. 7, 2016.

(51) Int. Cl. G06F 3/0485; G06F 17/21

(52) U.S. Cl. CPC G06F 3/04855; G06F 17/218; G06F 2203/014

(57) ABSTRACT

Systems and methods are provided to determine whether a first input to a web browser is received, the first input having at a first directional property, has a value that is greater than or equal to a first threshold value that corresponds to the first directional property. When the value is greater than or equal to the first threshold value, it is determined whether a second a second input is received, the second input having at least a second directional property. A message is displayed based on the determination that the determined at least one value is equal to or greater than the first threshold value that corresponds to the at least one property and the received second input having at least the second directional property.

### BACKGROUND

Users are increasingly relying on computing devices, such as personal computers, tablet computers, and smartphones to view content on webpages. For example, users may read text, view photos or videos, purchase products or services, and the like. However, the webpages may not be effective in continuing to engage a user, which may prevent the consuming of additional content, purchasing of a product or service, or receiving information as to how a user may further engage with the webpage or share content. In some instances, the user may become disengaged with a website while an interaction between the user and the website is occurring or is incomplete.

### BRIEF SUMMARY

According to an embodiment of the disclosed subject matter, systems and methods are provided to determine, at a computing device that displays a webpage in a web browser on a display, that a first input to the web browser is received, the first input having at least a first directional property. The first directional property of the first received input may be compared with a first threshold value that corresponds to the first directional property, the first threshold value stored at the computing device. Based on the comparing at the mobile computing device, it may be determined whether at least one value of the first directional property is equal to or greater than the first threshold value that corresponds to the at least one directional property. Based on the determination that at least one value of the first directional property is equal to or greater than the first threshold value that corresponds to the at least one directional property at the computing device, it may be determined whether a second input to the web browser is received, the second input having at least a second directional property. A message may be displayed based on the determination that the determined at least one value is equal to or greater than the first threshold value that corresponds to the at least one property and the received second input having at least the second directional property.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example method of determining whether a first input operation is greater than or equal to a threshold value, detecting whether a second input operation is received, and displaying a message on a computing device according to an embodiment of the disclosed subject matter.

FIGS. 2A-2E show example displays of a computing device and messages displayed depending on detected input operations according to an embodiment of the disclosed subject matter.

FIG. 3 shows a computing device according to an embodiment of the disclosed subject matter.

FIG. 4 shows a network configuration according to an embodiment of the disclosed subject matter.

FIG. 5 shows a server configuration according to an embodiments of the disclosed subject matter.

### DETAILED DESCRIPTION

Websites may provide a variety of content, including textual information, graphical information, video, audio, product information, service information, and the like to users. In some examples, the information may be related to news, education, entertainment, products, services, and the like. A user may engage with a webpage, for example, by scrolling down to continue to view content on the webpage. However, a user may scroll up to re-engage with a portion of the webpage, to search for content, or to exit the webpage (e.g., such as when using a web browser on a mobile device). That is, one problem addressed by embodiments of the disclosed subject matter is engaging the user with the displayed content, recommending other content, prompting the user to subscribe to content and/or provide information for a mailing list, and/or prompting the user to share and/or save the content.

Similarly, it may be difficult for content providers, media providers, education providers, publishers, entertainment entities, manufacturers, product resellers, and/or service providers and the like to engage users to complete a purchase of a product or service, and/or recommend a suitable product or service. That is, one of the problems addressed by embodiments of the disclosed subject matter is prompting the user to take steps to complete a transaction for a product or service, and/or present recommendations for a product or service.

Embodiments of the disclosed subject matter address the problem of re-engaging a user with a website when the user may no longer engaged with the content and/or may be attempt to exit. That is, a website may be interactive so as to encourage participation, sharing, consuming, providing information, and the like. Some users may experience difficulty, frustration, or may not be sufficiently informed or motivated to continue to engage with the website, and may scroll to the website in order to discover or re-discover content to engage with, or attempt to leave the website. The embodiments of the disclosed subject matter provide information, recommendations, messages, prompts, incentives, direction, and the like to users via webpage overlays and/or dynamically altering webpage content so as to re-engage the user with the website and encourage user interaction with the website.

Embodiments of the disclosed subject matter address the problem of assessing engagement by a user with a website, and displaying a message to re-engage the user. For example, this problem may be addressed by determining a time spent by a user with a website, determining a scroll speed of a user executing a scroll operation on a website, and/or determining how far a user a user has scrolled down on the webpage (i.e., depth of user engagement with a webpage), and/or a depth of the webpage. That is, embodiments of the disclosed subject matter may determine the messages to be displayed to the user to prompt them to continue to engage with the webpage or with related content.

Embodiments of the disclosed subject matter address the problem of determining when a user is no longer “discovering” the content of a webpage. For example, the user may scroll down the webpage to discover content, and may execute an upscroll operation when the user is no longer discovering the content. Embodiments disclosed herein may display one or more messages so as to re-engage the user with content of the webpage or with related content that a user may discover.

That is, the disclosed embodiments address the problems discussed above relating to a user's engagement with content on a webpage, and providing a message to maintain user engagement, well as other related problems.

Embodiments of the disclosed subject matter determine user engagement with a webpage. That is, a computing device may monitor a user's engagement by determining when a user scrolls down a webpage and how far the user scrolls. The computing device may determine whether the amount of the downscroll (amount, velocity and/or acceleration of scrolling down) is equal to or greater than a predetermined threshold, and may monitor user input to detect an upscroll operation (amount, velocity and/or acceleration of scrolling up) after the downscroll threshold is met. When the upscroll is detected, the computing device may display a message, for example to prompt the user to subscribe to receive additional content, recommend other and/or related content, and/or prompt the user to share and/or save the content. If the user is viewing content for a product or service, the computing device may display a message, for example to prompt and/or encourage the user to take next steps to purchase the product or service. Embodiments of the disclosed subject matter may monitor the time-on-site, scroll speed, and/or amount of content consumed (i.e., depth of page viewed) to determine when to display a message to engage the user with the content on the webpage and/or with other related content. For example, the depth of page may correspond to the furthest down the page the user has scrolled, to a content element positioned around a certain location down the page, a set of elements displayed to the user based on the user's scrolling down the page, and so on.

As used throughout, a scroll operation and/or scrolling may include a slide operation and/or sliding. That is, a scroll operation and a slide operation may be interchangeable and/or may be the same operation. In some implementations, the scroll operation and a slide operation may be different, based on the device used to perform the operation. For example, a scroll operation and/or scrolling may be typically associated with the viewing of a webpage on a desktop and/or laptop computing device, and a sliding operation may be typically associated with viewing a webpage on a mobile computing device.

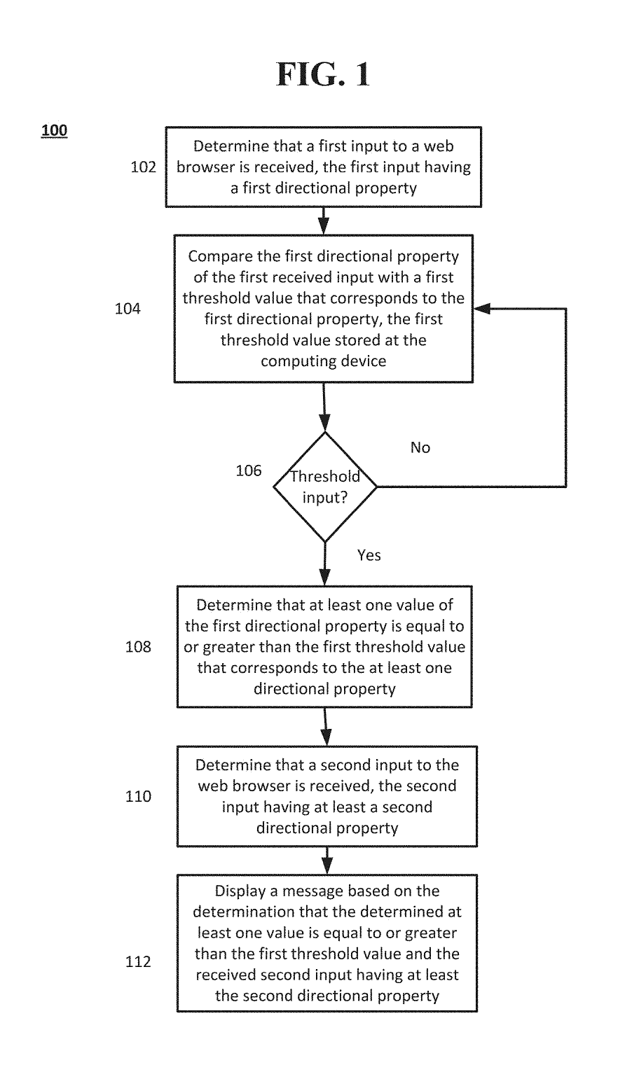

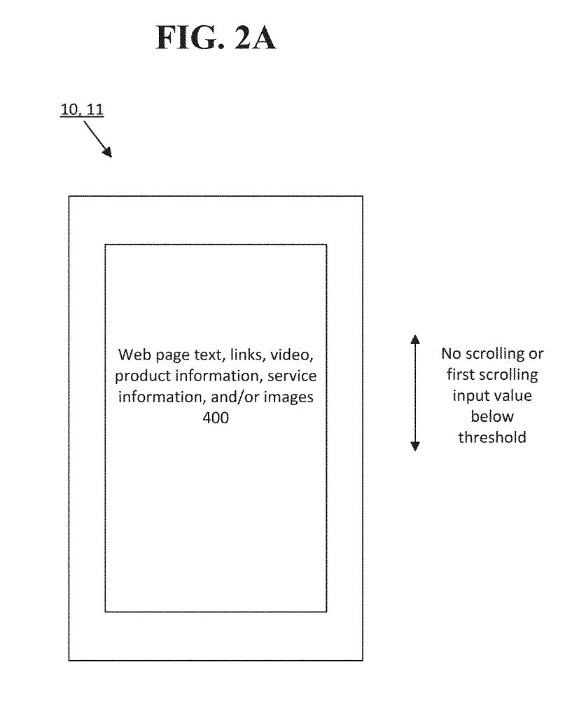

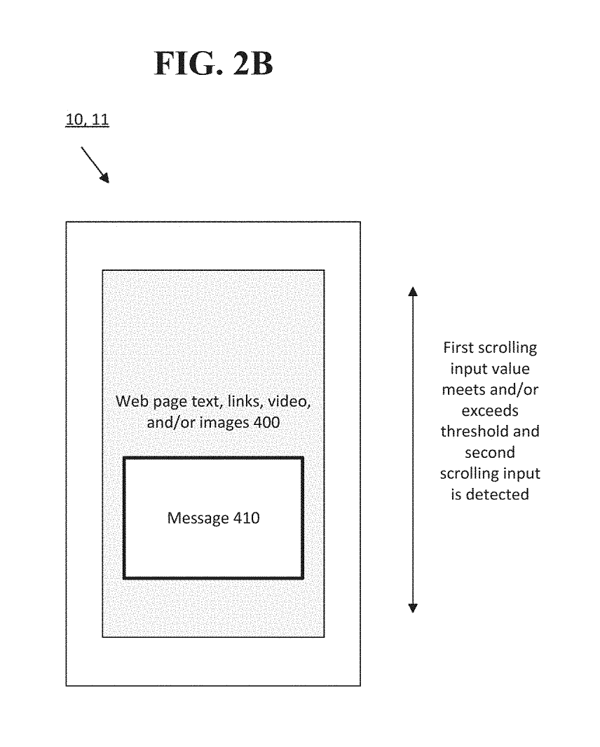

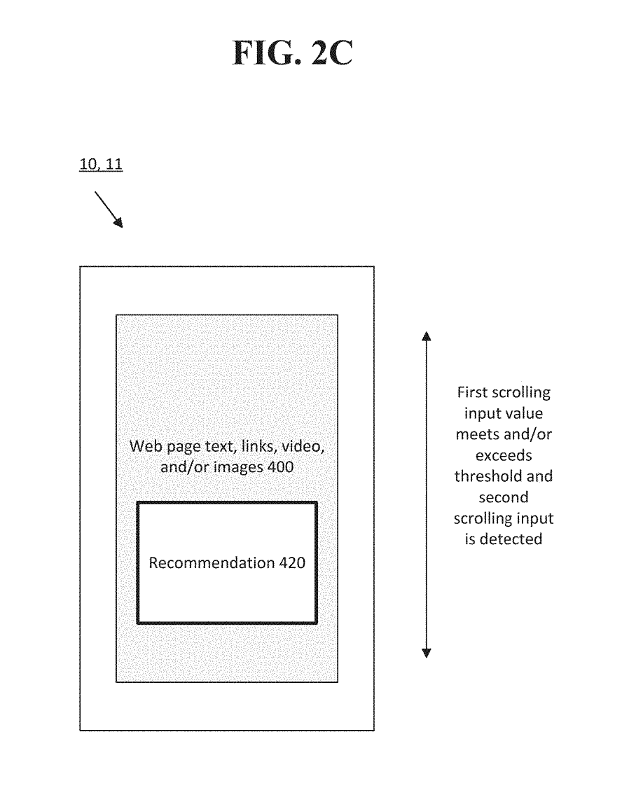

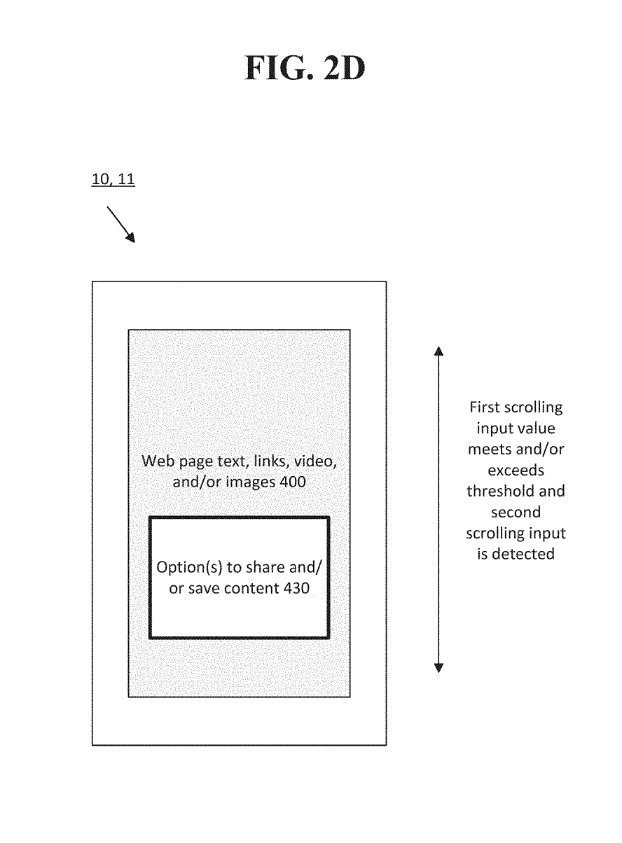

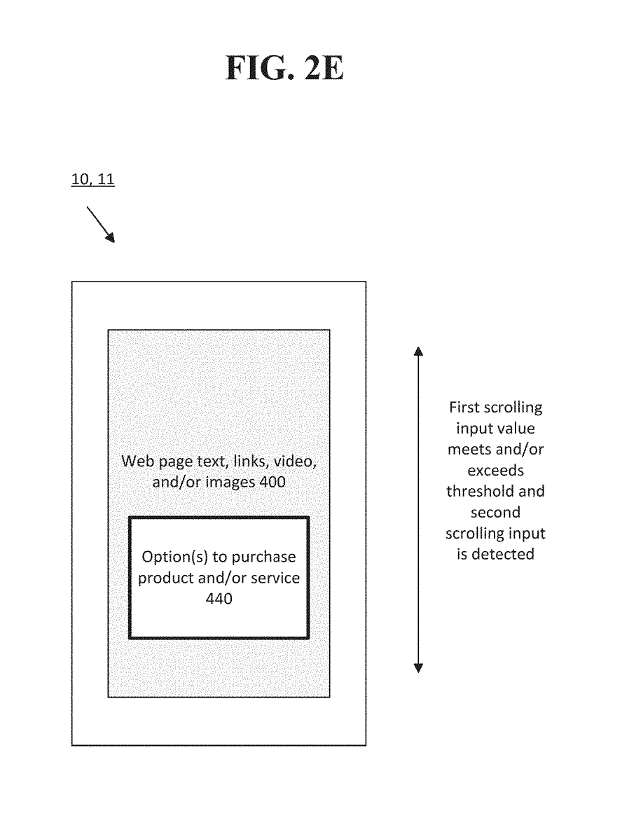

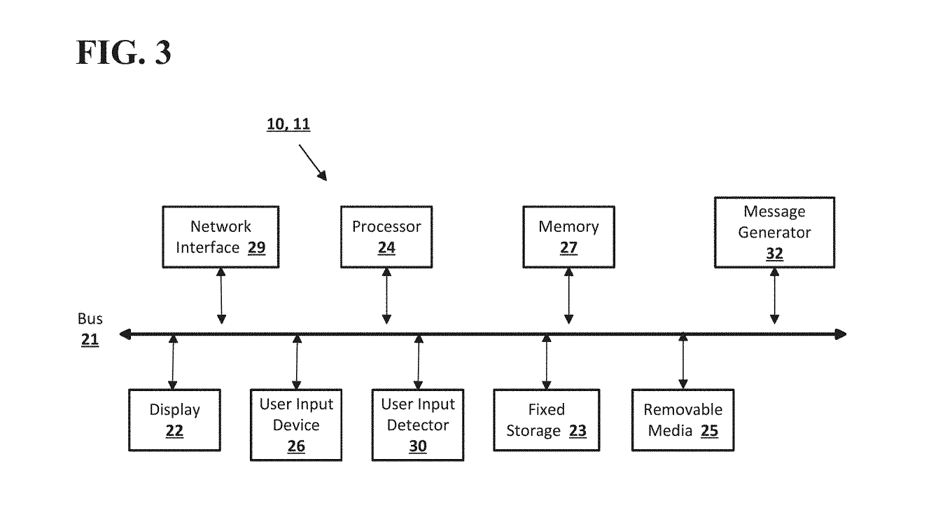

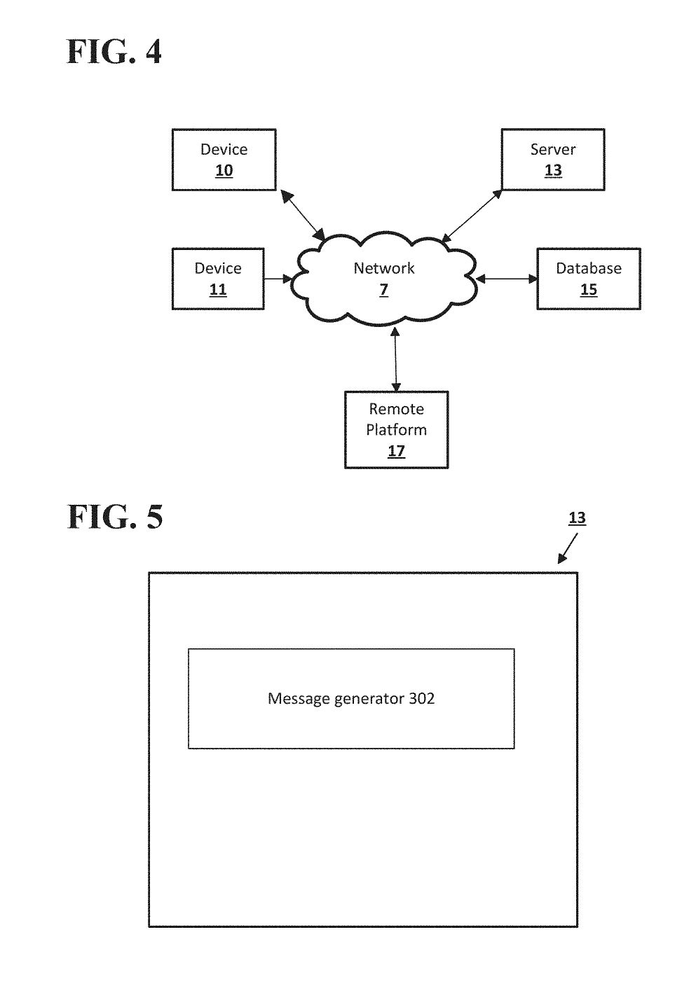

FIG. 1 shows an example method 100 for engaging a user viewing a webpage displaying a message on a computing device according an embodiment of the disclosed subject matter. At operation 102, a computing device may determine that a first input to a web browser that is displayed on a display is received, where the first input has at least a first directional property. In the operations of method 100, the first input (or a second input, as described below) may be selected from an upward scroll operation (i.e., an upscroll operation) and a downward scroll operation (i.e., a downscroll operation). The computing device may be computing device 10 and/or computing device 11, as shown in FIG. 2A-4 and described below. That is, the embodiments of the disclosed subject matter shown in FIGS. 3-4 may include one or more computing devices.

Examples of a directional property can include a direction and a magnitude, a velocity, an acceleration and a combination thereof. For example, the web browser of the computing device 10, 11 that displays a web page may receive a downscroll operation as the first input operation having a first directional property. That is, the user may execute the downscroll operation to view and/or interact with content being displayed. In some implementations of the method 100, the first input may be a downscroll operation and the second input, as described below in connection with operation 110, may be an upscroll operation.

In implementations of the disclosed subject matter, the first directional property in operation 102 (or a second directional property described below in connection with operation 110) may include a scrolling amount, a sliding amount, a velocity of a scroll operation or a slide operation, an acceleration of a scroll operation or a slide operation, or the like.

At operation 104, the computing device 10, 11 may compare the first directional property of the first received input with a first threshold value that corresponds to the first directional property, the first threshold value stored at the computing device. The first threshold value that may be stored at the computing device 10, 11 may include at least one of a threshold scroll value, a threshold slide value, at least one value corresponding to a threshold change in the display screen size of the web browser, or the like. In some implementations, the first threshold value in operation 104 may include a threshold percentage of the webpage that is scrolled by the upward scroll operation or the downward scroll operation, a number of pixels from a top of the webpage in the web browser, a position of one or more pixels in the webpage, or the like. In some implementations, the first threshold value in operation 104 may be a threshold percentage of the webpage that is scrolled by the received first operation.

In some implementations of the disclosed subject matter, the first threshold value in operation 104 may include at least one of an amount of time spent viewing the webpage in the web browser, a speed of the first directional property, an amount of content of the webpage viewed in the web browser, a depth of the webpage viewed in the web browser, and the like.

A threshold value, such as the first threshold value in operation 104, may be set for a value and/or amount of downscroll input is received. In some embodiments, the threshold value may be a percentage (e.g., 25%, 50%, 75%, or the like of a webpage has been viewed by one or more user downscroll operations). Alternatively, or in addition, the threshold value may be a vertical value on a webpage being displayed by the computing device 10, 11. Alternatively, the threshold may be a number of pixels from the top of the webpage, a maximum downscroll velocity value, and/or a maximum downscroll acceleration value. For example, a slower downscroll with lower acceleration may indicate that the user has perused more of the content of the webpage than a higher downscroll velocity/acceleration.

At operation 106, the computing device 10, 11 may determine whether the downscroll input is equal to or greater than the first threshold value. If the downscroll is less than the first threshold value or values, the computing device may continue to monitor input from the user to determine whether the downscroll input is equal to or greater than one or more threshold values. If the downscroll input at operation 106 is equal to or greater than a threshold input, operation 108 may determine that at least one value of the first directional property is equal to or greater than the threshold value that corresponds to the at least one directional property. That is, operation 108 may determine that a downscroll input is equal to or greater than a predetermined threshold.

In some implementations, the determining that the at least one value of the first directional property is equal to or greater than the first threshold value that corresponds to the at least one directional property in operation 108 may be based on determining a configuration of the computing device 10, 11. The configuration of the computing device 10, 11 may be based on at least one of an operating system, a model of the computing device 10, 11, a manufacturer of the computing device 10, 11, at least one operational setting of the computing device 10, 11, and the like.

At operation 110, the computing device 10, 11 may determine whether a second input to the web browser is received subsequent to the first input, the second input having at least a second directional property. For example, an upscroll operation may represent the second input and the second directional property, such as upscroll magnitude, velocity, acceleration or combination thereof. In some implementations, when it is determined that the second input to the web browser is received at operation 110, the computing device 10, 11 performs at least one of displaying a prompt to direct or incentivize a selection of a product or service to initiate a purchase, displaying a prompt to complete a form field of the webpage, adding a product or service to shopping cart of the webpage, displaying a prompt to complete a transaction for a product or service that is displayed on the webpage, displaying recommendations for a product or service, or the like. That is, a message may be displayed so as to direct, encourage, and/or incentivize a user to make a selection of a product and/or service displayed on the webpage to initiate a transaction, and/or display recommendations for related products and/or services (e.g., from different manufacturers and/or providers) to facilitate the user to initiate a transaction. If the product and/or service is has been selected, the message may direct encourage, and/or incentivize the user to add the product and/or service to a shopping cart associated with the webpage. If the user has added the product and/or service to the shopping cart, a message may be displayed to direct, encourage, and/or incentivize the user to complete the purchase and/or transaction. In some implementations, a prompt may be displayed to complete a form field of the webpage.

At operation 112, the computing device 10, 11 may display a message (e.g., message 410 shown in FIG. 2B) based on the determination that the determined at least one value is equal to or greater than the first threshold value that corresponds to the at least one property and the received second input having at least the second directional property. For example, an upscroll magnitude may correspond to a pixel or horizontal line of pixels on the web page, one or more content elements whose position is known on the web page, or the like. Alternatively, or in addition, the message may include a recommendation (e.g., recommendation 420 shown in FIG. 2C), options to share and/or save content (e.g., options 430 shown in FIG. 2D), and/or options to purchase a product and/or service (e.g., options 440 shown in FIG. 2E).

In some implementations, the operation 112 may include displaying, at the computing device 10, 11, at least one of a selectable image, selectable text, a selectable button, a selectable link, and the like. A user of the computing device 10, 11 may be redirected to information of interest based on a received selection of at least one of the selectable image, the selectable text, the selectable button, the selectable link, and the like. In some implementations, the redirection operation may include displaying, on the display 22 of the computing device 10, 11, the information of interest that may include at least one of the displayed message, a different portion of a website that includes the displayed webpage, a new webpage of a different website from the displayed webpage, an advertisement, and the like.

In some implementations, operation 112 may include generating or selecting, at a server (e.g., server 13 shown in FIG. 4) communicatively coupled to the computing device 10, 11, information to be generated or selected to be included with the message. The server 13 may transmit to the computing device 10, 11, via a communications network (e.g., network 7 shown in FIG. 4), the generated or selected information to be included in the message. The at least one of the generated information and the selected information may be displayed on display 22 of the computing device 10, 11 (e.g., as shown in FIG. 3) in an overlay or by dynamically adjusting the displayed webpage.

In some implementations, the displaying the message at operation 112 may include at least one of displaying a recommendation for content other than that displayed on the webpage, displaying a prompt to subscribe to content, displaying a prompt to provide information for a mailing list, receiving a selection to share content displayed on the webpage, receiving a selection to save the content displayed on the webpage, and the like.

In some implementations, the method 100 may include collecting data associated with a user or the computing device 10, 11. Based on the collected data associated with the user or the computing device 10, 11, at least one of the computing device 10, 11 or the server 13 may determine how the message of operation 112 is to be displayed on the display of the computing device 10, 11, and the content of the message. The data associated with the user or the computing device 10, 11 is may include data from the web browser of the computing device 10, 11, an operating system of the computing device 10, 11, whether a computer programming code has been enabled or disabled on the computing device 10, 11, a network connection speed of the computing device 10, 11, an enabled cookie on the computing device 10, 11, screen resolution settings of the computing device 10,11, received input to the web browser of the computing device 10, 11, and the like. In some implementations, the data associated with the user or the computing device 10, 11, may include user search criteria, user identification information, user preferences, user location, web browser information, characteristics of the computing device, previous visit history with a web page, referral history, and the like. The collected data associated with the user or the computing device 10, 11 may be at least partially used to determine the message to be displayed on the display 22 of the computing device 10, 11.

In the method 100 described above, a threshold scroll input value may be set in the computing device 10, 11 based on a direction (e.g., an “up” scroll direction, a “down” scroll direction), and/or may be based on a magnitude of the scrolling input received. The magnitude may be a percentage scrolled of the web page displayed on the user computing device. For example, the threshold value may be set to be receiving a scrolling input so that 20%, 50%, 65%, 75%, 80%, or the like of the web page being displayed is scrolled. A threshold value may be different based on, for example, a type of computing device 10, 11 (e.g., the brand, model, or the like), the operating system of the computing device 10, 11 (e.g., Windows™, OS X™, Linux™, iOS™, Android™, Windows™ Mobile, or the like), and/or the web browser user (e.g., Internet Explorer™, Chrome™, Safari™, or the like).

FIG. 2A shows the computing device 10, 11 having a display 400 which may include web page text, images, video, product information, service information, images, one or more selectable links to other web pages and/or other pages within the web site, and the like. The example display 400 as shown in FIG. 2A may not have received a first input (e.g., a downscroll operation), or may have received an input that is less than a threshold value, and/or may not have received a second input (e.g., an upscroll after detecting a downscroll operation that is greater than or equal to the threshold value).

When the first input (e.g., a downward scroll) is received that is equal to or greater than a threshold value, and a subsequent second input (e.g., an upscroll operation) is received (e.g., such as a second input received at operation 110 of FIG. 1), a message 410 may be displayed on and/or adjacent to the display 400 on the computing device 10, 11 at operation 112. For example, as shown in FIG. 2B, when the first input (e.g., an downscroll operation) meets and/or exceed the threshold value, and a second input (an upscroll operation) is received, a message about content the user is view and/or related content may be displayed as message 410.

The display of the message 410 (or recommendation 420, options 430, and/or options 440 shown in FIGS. 2C-2E) may be different based on, for example, a type of computing device 10, 11 (e.g., the brand, model, or the like), the operating system of the computing device 10, 11 (e.g., iOS™, Android™, Windows™ Mobile, or the like), and/or the web browser user (e.g., Chrome™, Safari™, or the like). The message 410, the recommendation 420, the options 430, and/or the options 440 shown in FIGS. 2C-2E may be displayed as an overlay, or may be dynamically integrated into the display 400. The content of the message 410, recommendation 420, the options 430, and/or the options 440 may be generated and/or selected according to the website browsing history of the user, data and/or metadata collected from the user and/or the user's interaction with the website or other websites, search query terms entered by the user, the user's interaction with the website, or the like.

The computing device 10, 11 and/or a server (e.g., server 13 and/or remote platform 17 shown in FIGS. 4-5) may generate and/or select information to be displayed as message 410 at operation 112, or which may be overlaid onto display 400 at operation 112. The information generation and/or selection of the content for message 410 may occur at any time before operation 112. For example, the information may be generated and/or selected from the message 410 may be before a first input and/or a second input is determined to be received, and/or the first input is greater than or equal to the threshold.

Information that may be of interest or relevance to a user to be displayed in the message 410 may generated, or selected from a stored set of information. The information may include, for example, text information, graphical information, video, information, options to download or purchase an application, a link to another web page (e.g., within the web page) and/or a different web site, offers for coupons and/or savings on a product and/or service, and/or any other suitable information. In some embodiments, the information may include, for example, advertisements, promotional materials and/or offers, coupons, discounts, and the like. The information selected and/or generated are discussed below in context with different types of webpages.

That is, at operation 112, a message 410 may be displayed with generated and/or selected information at the computing device 10, 11. As described above, this information in the message may be to engage the user with the web site, provide the user with information of interest (e.g., such as information about the content being viewed or related content), and/or redirect the user to applications, web sites, and/or other information of interest to the user. The interest of the user, generation of information, and/or the selection of information may be displayed as an overlay to the display 400, or the display 400 may be dynamically altered to include the generated and/or selected information.

In some embodiments, operation 112 may display a message that may include a recommendation, such as recommendation 420 shown in FIG. 2C. That is, the computing device 10, 11 may display recommendation 420 which may recommend similar and/or related content to the user based on the presently viewed content.

FIG. 2D shows an embodiment where the message displayed at operation 112 by the computing device 10, 11 may include one or more options to share the content on web page being viewed by the user, and/or save the content of the web page so as to be viewed at a later time. For example, the options 430 may include an option to share the content via email with one or more email addresses, share a link to the content via a text message to one or more contacts, and/or share the content and/or a link to the content via one or more social networks (e.g., Twitter™, Facebook™, and the like).

FIG. 2E shows embodiments where the message displayed at operation 112 by the computing device 10, 11 may include one or more options 440 to purchase a product and/or service that may be viewed as content in the display 400. For example, the options 440 may include options to purchase and/or provide incentives (e.g., rebate, discount, or the like) to purchase a product and/or service. One or more selected options 440 may prompt a user to enter customer information, billing information, payment information, contact information, or the like to advance the purchase of the product or service.

There may be a plurality of cases where it may be desirable to display a message to a user upon the occurrence of a sequence of downscroll and/or upscroll operations. For example, a message may be displayed after an upscroll operation is detected subsequent to a downscroll operation that is equal to or greater than a threshold value. In one example, when content is published on a webpage (e.g., a publisher's webpage), the user may scroll down the webpage so as to view the content, and may scroll up the webpage when the user has finished reading the content, and/or want to return to a different point in the webpage. The computing device 10, 11 may display a message (e.g., message 410) to engage the user. For example, depending how much of the content displayed on the webpage that has been viewed by a user (e.g., 25% of the webpage, 50% of the webpage, 75% of the webpage, or the like), the computing device 10, 11 may prompt the user to subscribe to a mailing list (e.g., via message 410), recommend other content (e.g., via recommendation 420), and/or encourage the user to save and/or share the content (e.g., via options 430).

Other examples of message triggers based on sequential operations include determining that a downscroll operation resulted in a downscroll magnitude equal to or greater than a downscroll magnitude threshold, e.g., a threshold within 30%-50% down the web page, a threshold 50%-70% within the webpage, or a threshold at a level more than 70% down the web page. Also, the computing device may determine that the downscroll operation never exceeded a maximum of N pixels per second. For example, N can be a number from 0 to 10, from 10 to 30, 20-50 or greater than 30. Then an upscroll operation may be detected with an upscroll magnitude that is greater M, where M is, for example, an absolute number of pixels or a number of pixels from the top of the web page. Further, the computing device may determine that the upscroll operation includes an acceleration that exceeds P pixels per second per second. These measurements can be compared to threshold numbers to determine if a message should be displayed based on the operations. For example, based on the determinations that the magnitude of the downscroll exceeded a downscroll magnitude threshold, the velocity of the downscroll operation did not exceed a downscroll velocity threshold, the magnitude of the upscroll operation exceeded an upscroll magnitude threshold and exceeded an upscroll acceleration threshold, a message may be displayed.

Other sequences may be used to determine if a message is to be displayed. For example, a first upscroll operation followed by a downscroll operation, followed by a second upscroll operation may be monitored by the computing device. Each of the foregoing operations may have its own directional property thresholds. For example, the first upscroll may have a first upscroll velocity threshold; the first downscroll operation may have a second downscroll magnitude threshold and a second downscroll velocity threshold; the second upscroll may have a second upscroll magnitude threshold, a second upscroll velocity threshold, and a third upscroll acceleration threshold. In an embodiment of the disclosed subject matter, a message may be displayed based on the determination that during such a sequence of monitored operations, the first upscroll magnitude did not meet or exceed the first upscroll magnitude threshold; the downscroll magnitude exceeded the downscroll threshold magnitude; and the second upscroll met the second upscroll magnitude threshold, exceeded the second upscroll velocity threshold and met the second upscroll acceleration threshold. In this way, a sequence of operations may be monitored and conditions may be set that, if met, trigger the display of a message. The conditions can include meeting or exceeding or not meeting the various thresholds in any combination that can indicate exit intent.

In one example, the webpage 400 displayed on the computing device 10, 11 may be a product page (e.g., that includes a product image, description, pricing information, and the like), and a user may scroll down on the webpage for more product details. That is, a user may be engaged with the webpage by performing one or more scroll down operations, and, upon activating a scroll up operation, the user may be ready to further engage with the webpage (e.g., take the next action to select the product for purchase, provide contact information, provide billing information, or the like). The computing device 10, 11, may determine a user's intent to purchase the product, and may prompt the user to take the next step in purchasing a product in options 440, or may recommend other products in options 440 and/or message 410.

In an example, message content (e.g., for message 410) may be selected based on time-on-site (i.e., how much time a user has actively been engaging with the website), scroll speed (e.g., the speed of a downscroll operation to discover the content of the webpage), depth of page (i.e., how far down a webpage a user has scrolled), and/or content consumed. In this example, the message content may be selected based on whether particular content and/or features of a webpage have been viewed by the user. The particular content may include text, images, video, graphics, or the like, and the features may include, for example, an option to select a product or service for purchase, an option to request information, an option to share and/or save content, an option to subscribe to content, or the like.

For example, when a time-on-site is determined to be greater than or equal to a predetermined threshold, a message 410 may be displayed to prompt the user to enter information to subscribe to the content. Options 430 may be displayed so as to prompt the user to share the content that the user is engaged with and enjoying. Alternatively, or in addition, a recommendation 420 may be displayed so as to recommend related content to the user. When the webpage relates to a product or service, and the time-on-site is determined to be greater than or equal to a predetermined amount, options 420 may be displayed so as to encourage the user to purchase the product or service.

When a scroll speed is determined to be greater than or equal to a predetermined threshold, a message 410 may be displayed to prompt the user to provide a recommendation 420 for content that may be related. For example, a fast scroll speed may indicate that the user is attempting to discover content to find specific information, and the recommendation 420 may direct the user to desired content.

The computing device 10, 11 may determine the engagement of the user (e.g., based on the first and/or second input operations), and dynamically select content for a message 410 to be displayed when an upscroll operation is detected subsequent to a downscroll operation that is equal to or is greater than a predetermined value.

For example, method 100 may be used to determine when the user is no longer engaged with the web page presented in display 400 (e.g., by detecting an upscroll operation after a predetermine threshold has been reached with a downscroll operation). A message may be presented to the user in the display 400 (i.e., where the content of display 400 is dynamically altered) and/or may be presented as message 410 to re-engage the user with the displayed content or with other content.

The computing device 10, 11 may display a message 410 to notify the user that additional information or content may be available, and the message 410 may include information about how to receive information. For example, the message 410 may include an option for the user to enter information such as an email address, phone number, mailing address, and/or any other suitable contact information so that the user may be provided with content and/or additional information.

In one example, a user may be viewing an article on a website displayed by the computing device 10, 11. As described above, an upscroll may be detected (i.e., after a downscroll operation is equal to or greater than a predetermined threshold), and the message 410 and/or options 430 may prompt the user to query whether they would like the article being viewed to be emailed to them or another person. The message 410 and/or options 430 may be used to capture an email (e.g., a user may enter their email address as prompted by the message 410), or may provide a link to a webpage for the user to enter their email address. Alternatively, or in addition, a link to the article may be texted to or emailed to the user or another person. The message 410 may query the user as to whether they would like to save their reading position in the article, so that they may return to the webpage again at the same location to resume reading.

Similar to the example above, a user may be finalizing a form for a request for information in the display 400, but may not include all of the required information. For example, the form may be for a subscription to content or to request information. The computing device 10, 11 may determine that the user ids disengaged with completing the form as the user may not understand what information is being requested from them, or the like, and may activate an upscroll operation. A message 410 may be displayed to point out to the user what information still needs to be provided to complete the form, and/or may offer examples of how to complete the form and/or incentives to complete the form.

In another example, when a user has completed reading an article that is being viewed in display 400 of the computing device 10, 11, an upscroll operation may be detected, as described above. Alternatively, in this example, the user may visit the website, but content may be displayed that the user is not interested in after scrolling down at least a portion of the article to discover the content, and the user may execute an upscroll operation after content discovery. When the upscroll operation is detected after a predetermined threshold has been reached with a downscroll operation, an article, product, service, content, information, and/or media recommendation may be displayed in recommendation 420. In some embodiments, the recommendation 420 may include link to the article, product, service, content, information, and/or media, and/or a summary of the same. The computing device 10, 11 and/or a server 13 may generate the recommendation. The recommendation may be based on, for example, at least one of an article, service, product, content, information, media, information, or the like that the publisher wishes to promote, the user viewing history, or the like.

In yet another example, a user may be viewing a website in display 400 of the computing device 10, 11, and an upscroll operation may be detected, as described above. For example, the user may not be able to locate the content, product, service, information, media, or the like that they may be looking for. When an upscroll operation is detected, the recommendation 420 may be display which may provide a suggestion for a category and/or product, service, media, and/or information page to the user. In some embodiments, a link to the category page or the product, content, service, information, and/or media page may be provided in the message 410, recommendation 420, or options 440. Such links to these webpages may be provided, for example, when it is determined that the user has not visited these webpages, and the products presented on the pages may be relevant to the user, given their search history, search query, or the like. In some embodiments, an incentive may be provided (e.g., a discount, a coupon, and offer for reduced cost content or subscription, or the like) so as to retain the interest of the user. This incentive may be related to the content that is linked to in the message 410, the recommendation 420, and/or options 440. This incentive may be to encourage the user to select the recommended link for the product, service, information, media, or the like that is provided in the message 410, recommendation 420, and/or options 440.

In another example, when a webpage displayed in display 400 of the computing device 10, 11 that requests that a user provide information, upon detection of an upscroll operation when a user has not completed a request for information (e.g., name, mailing address, phone number, email address, or the like), the message 410 may provide one or more incentives (e.g., additional information, discounts, membership privileges, special access to content and/or information, or the like) for the user to complete the entry of information. For example, the message 410 may direct the user to enter information that has not been previously provided, and/or that may have been skipped inadvertently.

In yet another example, a user may be attempting to purchase an item from a website displayed in the display 400 of the computing device 10, 11. An upscroll operation may be detected such that the user does not complete the process of purchasing the item. The options 440 may provide a link to a purchase or redirect the user to complete the purchase when the upscroll operation is detected as described above. For example, when the upscroll operation is detected, embodiments of the disclosed subject matter may attempt to re-engage the user with the webpage so as to encourage the purchase of an existing product or recommend a similar product to view and/or purchase (e.g., via message 410, recommendation 420, and/or options 440). In one embodiment, the user may receive an incentive such as a coupon for a future purchase, or a discount on the purchase to be completed, and/or may be provided with any other suitable incentive. Alternatively, or in addition, when an upscroll is detected as described above, the computing device may present a display (e.g., an overlay or the like) to inform the user that the purchasing transaction has not been completed, provide guidance for completing the purchasing transaction (e.g., alert the user as to what information items need to be entered), and/or provide any suitable message to re-engage the user with completing the purchasing transaction.

In another example, when an upscroll operation is detected as described above, the message 410 may provide promotional information to the user. In some embodiments, the user webpage viewing history may be used to determine whether a user has viewed any promotional materials and/or offers about a product, service, and/or information. When the user has not viewed any promotional content, or may have viewed the promotional content less than a predetermined number of times, the display 410 may provide information relating to the promotion. For example, the information may include the time period that the promotion is offered, the value of the promotion, the products, services, and/or information available via the promotion, and/or any other suitable information.

In some embodiments, the message 410 may include a link to a webpage that may be of interest to the user. The selection of the link may be based on the user's browsing and/or viewing history. When providing the link, the message 410 may provide a summary of information of the information in the page that the link is to.

In the examples above, the message, recommendations, and/or options may be displayed in an overlay, or the webpage displayed in display 400 may be dynamically altered so as to include the generated and/or selected information.

One or more embodiments of the disclosed subject matter may display a message on a display of a computing device when a first input is greater than or equal to a threshold, and a second input is received, based on the example code below:

```
var ca_id = 95632;
var scroll_pct = 99;
var triggerDirection = ‘up’;
bouncex.campaigns[ca_id].oldy = jQuery(window).scrollTop( );
bouncex.documentHeight = jQuery(document).height( );
winheight = jQuery(window).height( );
bouncex.lowestScrollreached = false;
var eventName =
(bouncex.browser.iphone | | bouncex.browser.ipad)&&bouncex.browser.c
hrome?‘touchmove’:‘scroll’;
bouncex.wind = bouncex.wndsize( );
jQuery(window).bind(eventName+‘.bouncex_scroll_’+ca_id,function(e
vent){
  var scroll = jQuery(window).scrollTop( );
  var up = (bouncex.campaigns[ca_id].oldy > scroll);
    bouncex.campaigns[ca_id].oldy = scroll;
  var pos = ((scroll +
bouncex.wind.height)/bouncex.documentHeight)*100;
  var diff = (pos)+(scroll_pct);
  var scrolled =
(jQuery(window).scrollTop( )/(bouncex.documentHeight −
winheight))*100;
if(triggerDirection==‘up’ && up &&
(diff>100 | | bouncex.lowestScrollreached)){
        setTimeout(function( ){
          / / display message to engage user
        },200);
        bouncex.lowestScrollreached=true;
  }else if(triggerDirection==‘up’ && !up){
      bouncex.campaigns[ca_id].ad_visible=true;
        bouncex.close_ad(ca_id);
  }else if(triggerDirection==1 down’ && !up && diff>100){
        / / display message to engage user
  }else if(triggerDirection==‘down’ && up){
        bouncex.close_ad(ca_id);
  }
});
```

In the example code above, when a first input (e.g., a downscroll operation) input is greater than a predetermined value, and a second input (e.g., an upscroll operation) is detected subsequent to a first scroll operation (e.g., an upscroll is detected subsequent to a downscroll operation), a message may be displayed on the computing device. A message may also be displayed based on the time spent by the user on the webpage. That is, when the time spent on the webpage is greater than a predetermined amount of time, a message may be displayed. The magnitude of the upscroll operation that is subsequent to the downscroll operation may be used to determine a message to be displayed on the computing device.

Embodiments of the presently disclosed subject matter may be implemented in and used with a variety of component and network architectures. FIG. 3 is an example computing device 10, 11 suitable for implementing embodiments of the presently disclosed subject matter. The device 10, 11 is shown in the context of a communication network in FIG. 4. The device 10, 11 may be, for example, a desktop computer, a laptop, and/or a mobile computing device such as a smart phone, tablet, wearable computing device, or the like. The device 10, 11 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection. The device 10, 11 may optionally include one or more of a user input detector 30 and/or a message generator 32.

The bus 21 allows data communication between the central processor 24 and one or more memory components, which may include RAM, ROM, and other memory, as previously noted. Typically, RAM is the main memory into which an operating system and application programs are loaded. A ROM or flash memory component can contain, among other code, the Basic Input-Output system (BIOS) which controls basic hardware operation such as the interaction with peripheral components. Applications resident with the device 10, 11 are generally stored on and accessed via a computer readable medium, such as a hard disk drive (e.g., fixed storage 23), an optical drive, solid state drive, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth(R), near-field, and the like. For example, the network interface 29 may allow the computer to communicate with other computers via one or more local, wide-area, or other communication networks, as described in further detail below.

User input detector 30 may include an integrated circuit, a processor, a programmable logic device, a sensor, and/or computer instructions implemented on a processor (e.g., processor 24) to detect input from a user via the user input device 26 and/or the display 22 (e.g., a touch-screen display). For example, the user input detector 30 may detect an input by the user to perform a scroll operation. In this example, the user input detector 30 may determine the magnitude and/or direction of one or more scroll operations. In some embodiments, the user input detector 30 may determine a percentage of a webpage displayed on the display 22 of the device 10, 11 is scrolled. In some embodiments, the user input detector 30 may determine when a second scroll is received that is an opposite direction than a first detected scroll operation.

Message generator 32 may include an integrated circuit, a processor, a programmable logic device, a sensor, and/or computer instructions implemented on a processor (e.g., processor 24) to generate information to be displayed in display 22 (e.g., in display 408 shown in FIG. 2C) when, for example, a downscroll operation is greater than or equal to a threshold value, and an upscroll operation is detected. The message generator 32 may determine a link to a webpage and/or website, recommend content, provide a message to prompt a user to share and/or save content being viewed on a web page, provide a message to prompt a user to purchase a product and/or service, provide a message to prompt the user to enter contact information (e.g., a name, an email address, or the like to subscribe to receive content).

Many other devices or components (not shown) may be connected in a similar manner (e.g., document scanners, digital cameras and so on). Conversely, all of the components shown in FIG. 3 need not be present to practice the present disclosure. The components can be interconnected in different ways from that shown. The operation of a computer such as that shown in FIG. 3 is readily known in the art and is not discussed in detail in this application. Code to implement the present disclosure can be stored in computer-readable storage media such as one or more of the memory 27, fixed storage 23, removable media 25, or on a remote storage location.

FIG. 4 shows an example network arrangement according to an embodiment of the disclosed subject matter. One or more devices 10, 11, such as smart phones, tablet computing devices, wearable computing devices and the like may connect to other devices via one or more networks 7. Each device 10, 11 may be a computing device as previously described. The network may be a local network, wide-area network, the Internet, or any other suitable communication network or networks, and may be implemented on any suitable platform including wired and/or wireless networks. The devices 10, 11 may communicate with one or more remote devices, such as servers 13 and/or databases 15. The remote devices may be directly accessible by the devices 10, 11, or one or more other devices may provide intermediary access such as where a server 13 provides access to resources stored in a database 15. The devices 10, 11 also may access remote platforms 17 or services provided by remote platforms 17 such as cloud computing arrangements and services. The remote platform 17 may include one or more servers 13 and/or databases 15.

FIG. 5 shows a server 13 according to an embodiment of the disclosed subject matter. The server 13 may include, for example, a message generator 302 which may be one or more processors, integrated circuits, programmable logic devices, and/or computer instructions executed on the same. The operation of the message generator 302 to message generator 32 described above in connection with FIG. 3.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
determining, at a computing device that displays a webpage in a web browser on a display, that a first input to the web browser is received, the first input having at least a first directional property;
comparing, at the computing device, the first directional property of the received first input with a first threshold value that corresponds to the first directional property, the first threshold value stored at the computing device;
determining, based on the comparing at the computing device, that at least one value of the first directional property is equal to or greater than the first threshold value that corresponds to the at least one directional property;
determining, based on the determining that at least one value of the first directional property is equal to or greater than the first threshold value that corresponds to the at least one directional property at the computing device, that a second input to the web browser is received, the second input having at least a second directional property; and
displaying, on the display of the computing device, a message based on the determination that the determined at least one value is equal to or greater than the first threshold value that corresponds to the at least one property and the received second input having at least the second directional property.

2. The method of claim 1, wherein the determining that the at least one value of the first directional property is equal to or greater than the first threshold value that corresponds to the at least one directional property is based on determining a configuration of the computing device.

3. The method of claim 2, wherein the determining the configuration comprises:
determining the configuration based on at least one from the group consisting of: an operating system, a model of the computing device, a manufacturer of the computing device, and at least one operational setting of the computing device.

4. The method of claim 1, wherein the first threshold value stored at the computing device includes at least one from the group consisting of: a threshold scroll value, a threshold slide value, and at least one value corresponding to a threshold change in the display screen size of the web browser.

5. The method of claim 1, wherein the displaying the message comprising:
displaying, at the computing device, at least one of a selectable image, selectable text, a selectable button, and a selectable link; and
redirecting, at the computing device, a user to information of interest based on a received selection of at least one of the selectable image, the selectable text, the selectable button, and the selectable link.

6. The method of claim 5, wherein the redirecting comprises:
displaying, on the display of the computing device, the information of interest in at least one from the group consisting of: the displayed message, a different portion of a website that includes the displayed webpage, a new webpage of a different website from the displayed webpage, or an advertisement.

7. The method of claim 1, wherein the first input or the second input is selected from the group consisting of: an upward scroll operation and a downward scroll operation.

8. The method of claim 7, wherein the first threshold includes at least one from the group consisting of: a threshold percentage of the webpage that is scrolled by the upward scroll operation or the downward scroll operation, a number of pixels from a top of the webpage in the web browser, and a position of one or more pixels in the webpage.

9. The method of claim 1, wherein the displaying the message comprises:
generating or selecting, at a server communicatively coupled to the computing device, information to be generated or selected to be included with the message; and
transmitting, from the server to the computing device via a communications network, the generated or selected information to be included in the message.

10. The method of claim 9, further comprising:
displaying, at the display of the computing device, the at least one of the generated information and the selected information in an overlay or by dynamically adjusting the displayed webpage.

11. The method of claim 1, further comprising:
collecting data associated with a user or the computing device;
based on the collected data associated with the user or the computing device, determining at least one from the group consisting of: how the message is to be displayed on the display of the computing device, and the content of the message.

12. The method of claim 11, wherein the data associated with the user or the computing device is at least one from the group consisting of: the web browser of the computing device; an operating system of the computing device; whether a computer programming code has been enabled or disabled on the computing device; a network connection speed of the computing device; an enabled cookie on the computing device; screen resolution settings of the computing device; and received input to the web browser of the computing device.

13. The method of claim 11, wherein the data associated with the user or the computing device includes at least one from the group consisting of: user search criteria; user identification information; user preferences; user location; web browser information; characteristics of the computing device; previous visit history with a web page; and referral history.

14. The method of claim 11, wherein the collected data associated with the user or the user device is at least partially used to determine the message to be displayed on the display of the computing device.

15. The method of claim 1, wherein the first threshold value is a threshold percentage of the webpage that is scrolled by the received first operation.

16. The method of claim 1, wherein the displaying the message comprises at least one from the group consisting of: displaying a recommendation for content other than that displayed on the webpage, displaying a prompt to subscribe to content, displaying a prompt to provide information for a mailing list, receiving a selection to share content displayed on the webpage, and receiving a selection to save the content displayed on the webpage.

17. The method of claim 1, when it is determined that the second input to the web browser is received, the computing device performs at least one from the group consisting of: displaying a prompt to direct or incentivize a selection of a product or service to initiate a purchase, displaying a prompt to complete a form field of the webpage, adding a product or service to shopping cart of the webpage, displaying a prompt to complete a transaction for a product or service that is displayed on the webpage, and displaying recommendations for a product or service.

18. The method of claim 1, wherein the first input is a downscroll operation and the second input is an upscroll operation.

19. The method of claim 1, wherein at least one of the first directional property and the second directional property is selected from the group consisting of: a scrolling amount, a sliding amount, a velocity of a scroll operation or a slide operation, and an acceleration of a scroll operation or a slide operation.

20. The method of claim 1, wherein the first threshold value includes at least one from the group consisting of: an amount of time spent viewing the webpage in the web browser, a speed of the first directional property, an amount of content of the webpage viewed in the web browser, and a depth of the webpage viewed in the web browser.
